(19) United States
(12) Patent Application Publication
(10) Pub. No.: US 2023/0289901 A1
(43) Pub. Date: Sep. 14, 2023

(54) OPERATING SYSTEM AND BLOCKCHAIN FOR ENERGY SUPPLY CHAIN

(71) Applicant: LIION, LLC, East Dundee, IL (US)

(72) Inventor: Gary L. GRAY, Tampa, FL (US)

(73) Assignee: LIION, LLC, East Dundee, IL (US)

(21) Appl. No.: 17/984,920

(22) Filed: Nov. 10, 2022

Related U.S. Application Data
(60) Provisional application No. 63/277,712, filed on Nov. 10, 2021.

(51) Int. Cl. G06Q 50/06; G06F 16/23; H02J 13/00

(52) U.S. Cl. CPC G06Q 50/06; G06F 16/2379; H02J 13/00

(57) ABSTRACT

A lithium-ion battery system (LBS), energy supply chain, and method of governing and recording energy management events are disclosed. The LBS may comprise at least one battery cell, at least one battery module, and a control unit. The energy supply chain may comprise a generator, a distributor, a consumer, an energy storage system, and a plurality of control units connected to each component of the supply chain. The control unit is configured to govern and record energy management events by connecting to a blockchain and by creating, validating, appending, and executing energy management events as blocks on the blockchain. The energy management events includes a power optimization for a single component of the energy supply chain and transactions between two components of the energy supply chain.

### CROSS-REFERENCE TO RELATED APPLICATION

This is a non-provisional U.S. Pat. application claiming priority under 35 U.S.C. §119(e) to U.S. Provisional Pat. Application No. 63/277,712 filed on Nov. 10, 2021.

### TECHNICAL FIELD

The present disclosure generally relates to methods of energy management and, more specifically, to an operating system and blockchain configured to manage and integrate components of an energy supply chain.

### BACKGROUND

An operating system, also known as an ‘OS’, is a low-level system software that handles the interface to a computing system’s hardware and provides services for high-level applications. For example, an operating system may allocate hardware resources such as memory and processing power, generate processor schedules, and manage input/output devices. Operating systems are used in many computing systems, such as but not limited to personal computers, embedded computers, microcontrollers, human-machine interfaces, and many other devices, including the computing systems involved in managing components of an energy supply chain.

A blockchain is a computer-implemented technology for storing, securing, and sharing data. The blockchain is a decentralized ledger of records, called blocks, linked together using cryptography, and stored on a network of nodes. According to many implementations, the blocks and the data stored therein cannot be retroactively altered without a network majority, effectively implementing data immutability. Blockchain technology originated with the advent of cryptocurrency, but new uses cases are being developed in fields such as healthcare, supply chain management, contract management, and many others.

An energy supply chain and, specifically, an electrical supply chain, may comprise, among other components, generators, distributors, consumers or end-users, and storage systems. However, modern components of energy supply chains are often managed by separate entities who utilize disparate hardware, software systems, operating systems, and communication protocols. The resulting supply chain leaves much to be desired in terms of interoperability between components and system scalability. For example, an energy transaction between two parties or components of the supply chain may require live personnel to initiate and a third party to arbitrate, increasing the cost of transaction as well as the room for error. In another example, each party or component of the supply chain may house its own, private reservoir of data, creating a phenomenon known as data silos, wherein valuable information available to only one party is not utilized to its full benefit for the supply chain as a whole. Lack of interoperability within an energy supply chain may negatively impact market liquidity, transmission efficiency, supply chain security, and much more. As the technology for each component of an energy supply chain advances, so too must the systems which enable these components to communicate, collaborate, and trade. However, existing energy-specific management systems have failed to integrate components of an energy supply chain in a manner that is altogether secure, scalable, interoperable, hardware-agnostic, decentralized, and automated.

One example of prior art may be found in U.S. Pat. No. 8,954,612 invented by Sudhir K. Giroti and assigned to Bridge Energy Group, Inc. Giroti discloses an energy management method in a Smart Grid environment, comprising a translation module coupled to and configured to translate data received from various components of an energy supply chain. The method and modules of Giroti are configured to improve communications and reduce transactional friction between components, so as to facilitate automated energy management events and improve energy delivery efficiency within the Smart Grid environment. However, the Smart Grid taught by Giroti employs multiple central servers, including a translation server, communication server, application engine server, validation server, etc., which are integral to the Grid’s protocols. Giroti thus teaches a centralized, as opposed to decentralized, system for managing energy-specific data and transactions. Unfortunately, such a centralized system may increase the Grid’s susceptibility to data manipulation, data loss, and cyberattacks.

Accordingly, there remains a need in the art for an operating system and a method of connecting disparate components of an energy supply chain, for efficiently managing and sharing their respective data, for securely arbitrating and recording their transactions, and for optimizing their internal processes, all while increasing the level of automation and decentralization of the system as a whole.

### SUMMARY OF THE DISCLOSURE

According to a first aspect of the present disclosure, a computer-implemented method of governing and recording energy management events is disclosed. The method comprises a component of an energy supply chain connecting to a blockchain recording a ledger of past energy management events; creating a new block recording a new energy management event; validating the new block through a network of interconnected nodes; appending the new block to the blockchain; and executing the new energy management event. The blockchain is stored on the network of interconnected nodes.

According to a second aspect of the present disclosure, a lithium-ion battery system (LBS) electrically connected to an energy supply chain is disclosed. The LBS comprises at least one battery cell, each cell having one or more cell metrics; at least one battery module electrically connecting the cells, each module having one or more module metrics; and a control unit operatively connected to the cells and the modules, the control unit being configured to monitor and control the cell metrics, the module metrics, one or more system metrics, and one or more system states. The control unit further runs a computer-implemented method of governing and recording energy management events involving the LBS. The method includes connecting to a blockchain recording a ledger of past energy management events; creating a new block recording a new energy management event; validating the new block through a network of interconnected nodes; appending the new block to the blockchain; and executing the new energy management event. The blockchain is stored on the network of interconnected nodes.

According to a third aspect of the present disclosure, an energy supply chain is disclosed. The energy supply chain comprises a generator that generates electrical power from a non-electrical source; a distributor that distributes electrical power between one or more components of the energy supply chain; a consumer that consumers electrical power; an energy storage system that converts and stores electrical energy to a non-electrical source; and a plurality of control units each operatively connected to one of the generator, the distributor, the consumer, and the energy storage system. Each control unit further runs a computer-implemented method of governing and recording energy management events. The method includes connecting to a blockchain recording a ledger of past energy management events; creating a new block recording a new energy management event; validating the new block through the network of interconnected nodes; appending the new block to the blockchain; and executing the new energy management event. The blockchain is stored on the network of interconnected nodes.

These and other aspects and features of the present disclosure will be more readily understood after reading the following description in conjunction with the accompanying drawings.

### BRIEF DESCRIPTION OF THE DRAWINGS

FIG. 1 is a diagram of an energy supply chain according to an embodiment of the present disclosure.

FIG. 2 is a perspective view of an LBS and its components, including a battery cell, battery module, and control unit, according to an embodiment of the present disclosure.

FIG. 3 is a schematic of a hardware system of a control unit according to an embodiment of the present disclosure.

FIG. 4 is a schematic of a software system of a control unit and a blockchain according to an embodiment of the present disclosure.

FIG. 5 is a schematic of an artificial intelligence program implemented by the hardware and software system of a control unit and a blockchain according to an embodiment of the present disclosure.

FIG. 6 is a flowchart depicting a method of governing and recording energy management events according to an embodiment of the present disclosure.

FIG. 7 is a flowchart depicting a method of managing energy transaction events according to an embodiment of the present disclosure.

FIG. 8 is a flowchart depicting a method of managing power optimization events according to an embodiment of the present disclosure.

### DETAILED DESCRIPTION

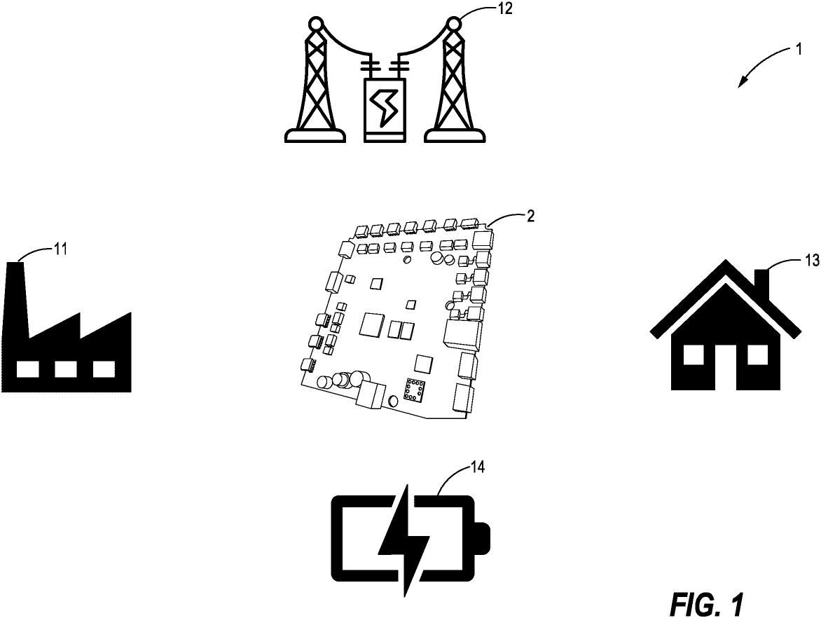

Referring now to the drawings and with specific reference to FIG. 1, an energy supply chain is generally referred to by a reference numeral 1. The energy supply chain 1 may comprise one or more generators 11, one or more distributors 12, one or more consumers or end-users 13, and one or more energy storage systems 14 electrically connected as part of an electrical grid. Furthermore, a control unit 2 may be operatively connected to each of the components of the energy supply chain 1. The control unit 2 runs an operating system 200 that implements a method of governing and recording energy management events. Through the control unit(s) 2, the components of the energy supply chain 1 are operatively connected to a decentralized blockchain 3 which records a ledger of all past energy management events. Each control unit 2, and indeed each component of the supply chain 1, may utilize the blockchain 3 as a source of data and/or as a secure arbitrator for transactions with other components.

With continued reference to FIG. 1, the one or more generators 11 may be, for example, a coal-fired power station, a solar power inverter, a wind turbine inverter, or any other technology that generates electrical power from a non-electrical source. Generated electrical power may be transmitted by the one or more distributors 12, which may include both electrical power transmission and electrical power distribution networks as commonly understood in the art, for example through transmission lines, transformers, substations, and adjoining infrastructure. Electrical power is received by consumers or end-users 13, which may include residential homes, commercial buildings, industrial applications, and any other consumer of electrical power. Finally, the supply chain 1 comprises one or more energy storage systems 14 that convert and store electrical energy to non-electrical sources. The energy storage systems may employ various technologies, such as but not limited to pumped hydroelectric, compressed air, flywheels, and/or batteries; and the storage systems may be used, among other purposes, to balance market demand, to reserve emergency power, and/or to improve an energy efficiency of the supply chain 1.

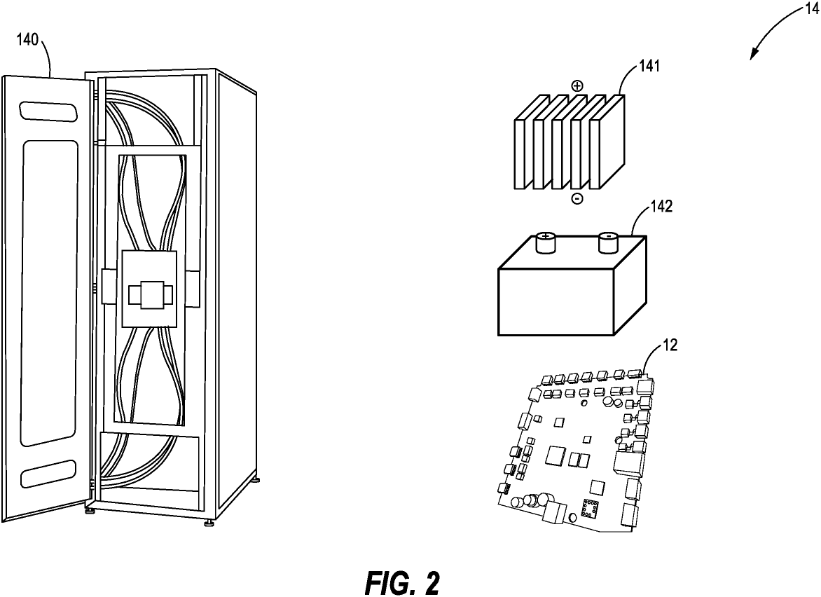

In an exemplary embodiment shown in FIG. 2, an energy storage system 14 in the form of a lithium-ion battery system (LBS) 140 is shown. The LBS 140 may act as a standalone energy storage solution, e.g. an accumulator, or it may act as a primary power source or secondary power source for another device, e.g. an uninterruptible power supply (UPS). Regardless, the LBS 140 may be electrically connected to an energy supply chain 1 and be capable of both charging and discharging electrical power thereto. The LBS may comprise at least one battery cell 141, each cell having one or more cell metrics; at least one battery module 142 electrically connecting the cells 141, each module 142 having one or more module metrics; and a control unit 2 operatively connected to the cells 141 and modules 142.

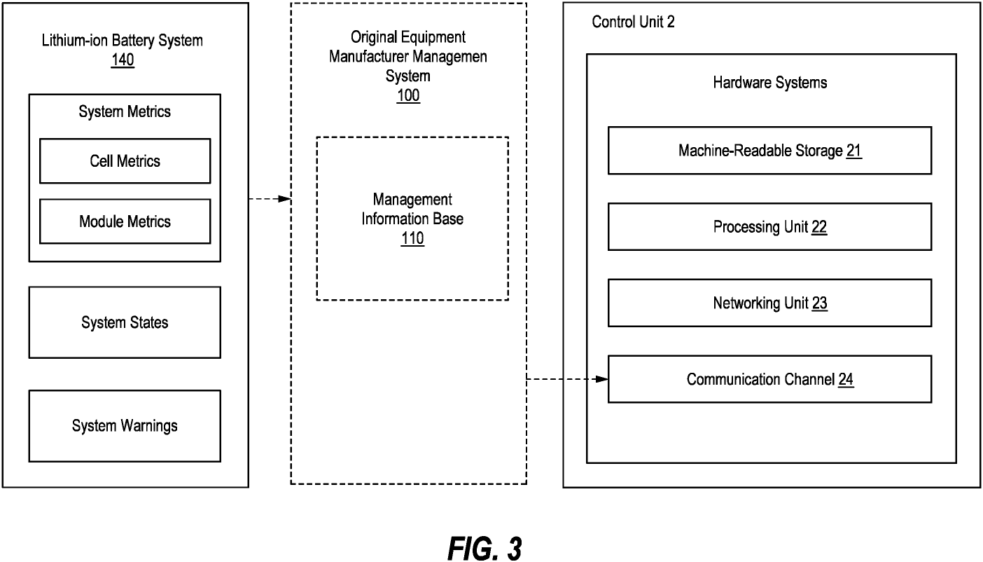

Referring now to FIG. 3., the control unit 2 may be configured to monitor and control the cell metrics and the module metrics of the LBS 140, and to further report one or more system metrics, one or more system states, and/or one or more system warnings. For example, the cell metrics may include one or more cell voltages, cell states of charge, cell temperatures, cell charging or discharging currents, etc.; the module metrics may include one or more module voltages, module states of charge, module temperatures, module charging or discharging currents, etc.; and the system metrics may include a total system voltage, system state of charge, system charging and discharging currents, etc. The control unit 2 may further monitor and control one or more system states, including contactor states, cell balance states, module balance states, etc.; one or more system warnings or system alarms; and yet other metrics and states of the LBS 140, where the type, resolution, and/or quantity of information available to the control unit is limited only by the hardware and applicational requirements of the LBS 140.

The control unit 2 may comprise at least a machine-readable storage medium 21, a processing unit 22, and a networking unit 23. In some embodiments, the control unit 2 may interface directly with the cells 141 and the modules 142 of the LBS 140, for example through proprietary circuitry, sensors, data acquisitions systems, and the like. In other embodiments, the control unit may instead interface with the cells 141 and the modules 142 of the LBS 140 indirectly through a management system 100 of the original equipment manufacturer (OEM), such as a battery management system, balancing board, OEM control unit, and the like. In the latter scenario, the control unit 2 may further comprise a communication channel 24 connecting the control unit 2 with the OEM system 100. The communication channel 24 may utilize a Modbus RTU protocol, Modbus TCP protocol, Modbus TCP/IP protocol, Alber™ BXE protocol, or similar standard transmission protocol to communicate with the OEM system and operatively connect to the cells 141 and the modules 142 of the LBS 140. In some embodiments, the control unit 2 may further be configured with a Simple Network Management Protocol (SNMP) to identify and supply LBS metrics from a Management Information Base (MIB) 110 associated with the OEM system 100. In this manner, the control unit 2 may interface with, query, and manipulate a variety of different battery systems regardless of the underlying system hardware or overall battery topology. Once a connection is established between the control unit 2 and the LBS 140, the networking unit 23 may operatively connect the control unit 2 to the blockchain 3 and facilitate data transfer therebetween.

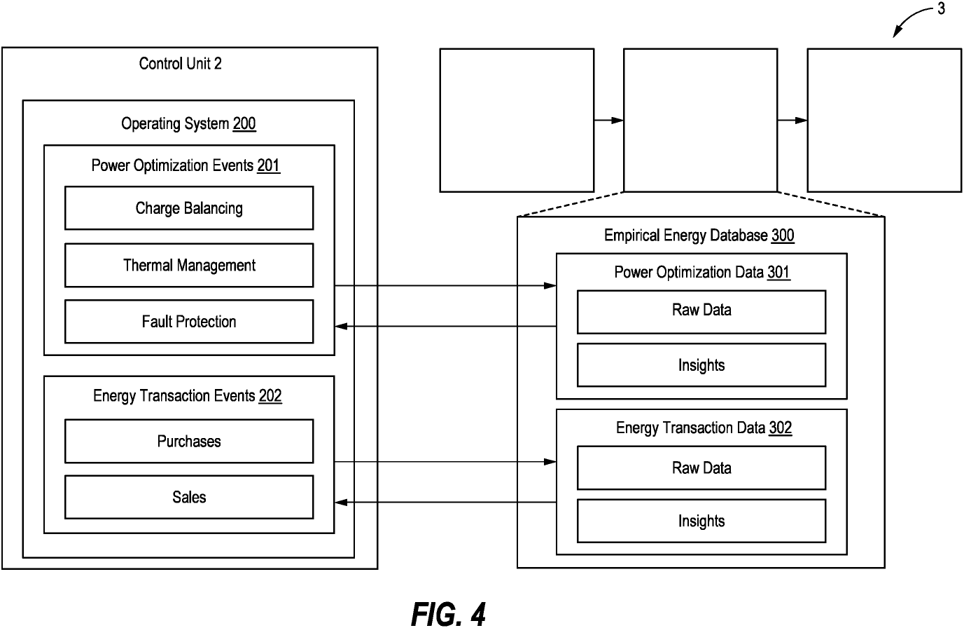

Turning now to FIG. 4, the control unit 2 runs an operating system 200 that enables a computer-implemented method of governing and recording energy management events on a blockchain 3. On a high level, the blockchain 3 assists the control unit 2 in managing at least two, interdependent processes. According to a first process, the control unit 2 may manage power optimizations 201 internal to the LBS 140 to improve the battery’s performance, safety, and/or reliability - similar to the processes of a battery management system. According to a second process, the control unit 2 may negotiate, execute, and record energy transactions 202 between the LBS 140 and one or more components of the energy supply chain 1, where each transaction may represent an exchange between a unit of energy and a financial instrument. To assist the the power optimization events 201, the control unit 2 may utilize the blockchain 3 as a source of past power optimization data 301, which can be analyzed to improve future power optimization performance. To assist the energy transaction events 202, the control unit 2 may utilize the blockchain 3 as a source of past energy transaction data 302, which can be analyzed to improve future transaction performance. Lastly, the control unit 2 may utilize the blockchain 3 as a secure arbitrator for the transaction.

With regard to the first process, the control unit 2 may run an operating system 200 responsible for power optimizations 201 internal to the LBS 140, performing passive and/or active processes to improve a performance, safety, and/or reliability of the LBS 140. For example, the control unit 2 may operatively shuffle power between a first cell and a second cell of the same module 142 to maintain the same cell voltage or cell state of charge, i.e. charge balancing; it may divert coolant flow to maintain the operating temperature of the LBS 140, i.e. thermal management; or it may open/close contactors after detecting an over-current or over-voltage warning, i.e. fault protection. The type and number of power optimization 201 events manageable by the control unit 2 may be limited only by the hardware and the applicational requirements of the LBS 140.

To improve the efficacy of the power optimization events 201, the control unit 2 may connect to an empirical energy database 300 stored on the blockchain 3. The energy database 300 may maintain a secure and immutable record of past power optimization data 301, which may include information describing the metrics of the LBS 140, past optimization events 201 executed by the control unit 2, the measurable results of these events, and even insights derived from analyses of the events. The data may be sourced from the same LBS 140, a different LBS connected to the blockchain 3, or a different component of the energy supply chain 1 altogether. For example, a second LBS employing the same cell chemistry and module configuration may have performed within a specific operating range, including a charging current range, discharging current range, average energy delivery between charge cycles, etc., resulting in an above average (or below average) battery state of health (SoH). The metrics, power optimization events 201, results, and insights of the second LBS may be stored on energy database 300, and may be accessible to the present LBS 140. Indeed, the power optimization data 301 of the second LBS, other LBS’s, other energy storage systems 14, and other types of components of the energy supply chain 1 may be accessibly stored on the blockchain 3 and made available to all connected parties. As the LBS 140 accesses the blockchain 3, it may further contribute data from its own metrics and power optimization events 201 to populate the energy database 300.

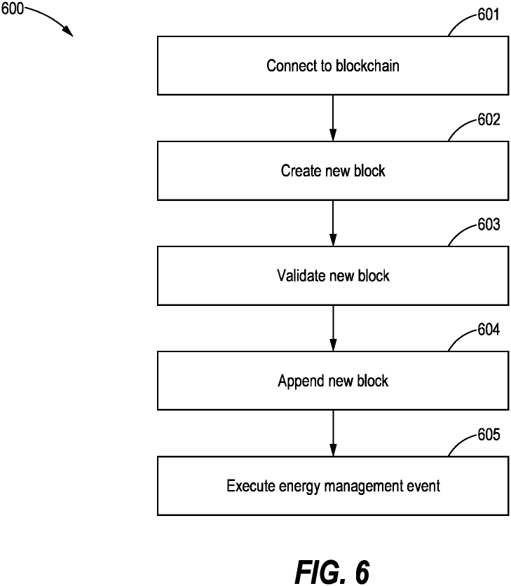

In an embodiment, the control unit 2 may further employ an artificial intelligence (AI) program 210 to manage its power optimization events 201. Referring now to FIG. 6, the AI may analyze, among other things, a baseline ruleset 211 and the past power optimization data 301 recorded on the energy database 300 to improve a performance of future power optimization events 201 in accordance with predetermined goals. The baseline ruleset 211 may be based on proprietary data and/or accepted industry practices specific to the LBS’s 140 cell chemistry, module configuration, and overall battery topology. The purpose of the baseline ruleset 211 is to constrain the decision-making of the AI 210 within a safe solution space and to prevent dangerous experimentation during the power optimization event 201. For example, a baseline rule may restrict a particular LBS to a maximum pulse discharge current of 120A, in which case the AI 210 would never overrun these constraints regardless of predicted benefits.

In some embodiments, the LBS 140 may utilize insights stored on the empirical energy database 300, i.e. pre-analyzed data yielding actionable results, to inform its actions. In other embodiments, however, the AI 210 may instead analyze raw data to arrive at its own insights. For example, the AI 210 may utilize raw data recorded on the energy database 300 as training data in a machine learning algorithm, such as a neural network. If actionable results are extracted from the analysis, the LBS 140 may optionally record these insights on the database 300.

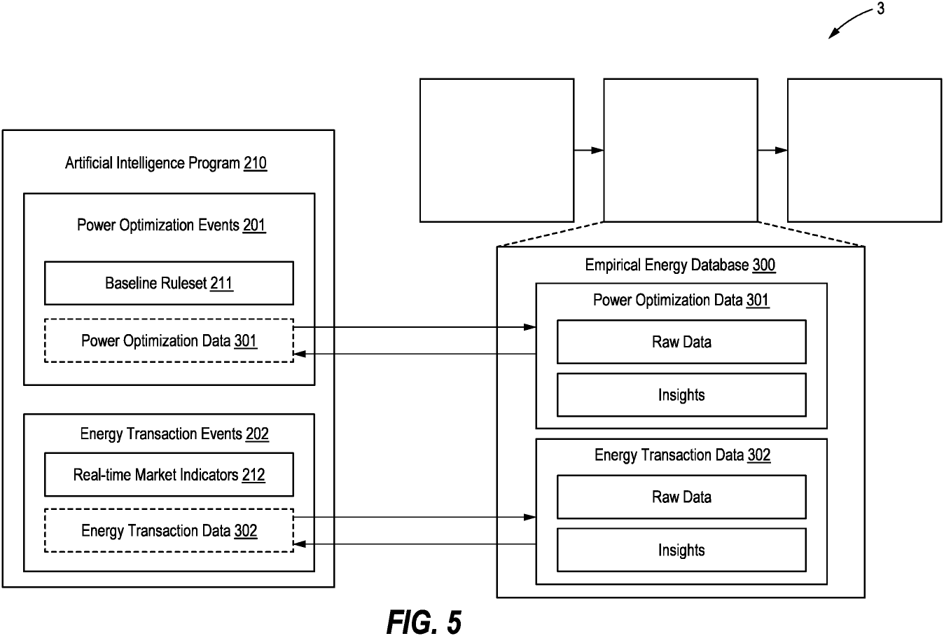

Referring again to FIG. 5, according to a second process, the control unit 2 may run an operating system 200 that manages energy transactions events 202 between the LBS 140 and one or more components of the energy supply chain 1. For example, the LBS 140 may purchase a quantity of electricity from a generator 11, distributor 12, or second energy storage system 14; the LBS 140 may sell a quantity of electricity to the distributor 12, second energy storage system 14, or consumer 13; or the LBS 140 may maintain its current energy holdings. Each of these energy transactions 202 may be securely arbitrated and immutably recorded on the blockchain 3 without the need for an intermediary or central authority. In an embodiment, each transaction 202 may be between a unit of energy, e.g. a watt-hour, and a native digital asset of the blockchain.

To improve a financial performance of the transactions 202, the control unit 2 may utilize past transaction data 302 stored on the energy database 300 to guide its future trading decisions. The transaction data 302 may be contributed from the same LBS 140, from a different LBS connected to the blockchain 3, from a different energy storage system 14, or from a different component of the energy supply chain 1 altogether. For example, a second LBS may have purchased electricity from a distributor within a certain time period, for a certain quantity, and/or at a certain frequency, resulting in an above average (or below average) cost. The energy transaction data 302 may be stored on the blockchain 3 and may be made accessible to the present LBS 140. No limitation is intended for the quantity or type of financial data recorded, which may include without limitation order types, quantities, prices, dates, and other financial information. Furthermore, as the LBS 140 accesses the database 300 for past transaction data 302, it may further contribute data from its own transaction events 202.

In some embodiments, the control unit 2 may employ an AI program 210 to automatically manage its transactions 202. As seen in FIG. 6, the AI program 210 may perform analogous functions regarding both the power optimization events 201 and the energy transaction events 202. In particular, the AI 210 may consider, among other factors, the past energy transaction data 302 retrieved from the energy database 300 and one or more real-time market indicators 212 in order to improve the LBS’s 140 transaction performance according to predetermined goals. For example, the market indicators 212 may include spot electricity prices, futures electricity prices, trading volume, historic trends, etc., where no limitation is intended for the type or number of indicators 212 being analyzed. At the same time, the AI 210 may analyze past transaction data 302 recorded on the blockchain. For example, real-time electricity spot prices may predictably cycle in daily, weekly, or seasonal time-scales - patterns which can be exploited by the AI 210 to improve the LBS’s 140 energy efficiency or operating costs.

In some embodiments, the LBS may utilize transaction insights stored on the blockchain 3, i.e. pre-analyzed data yielding actionable results, to inform its actions. In other embodiments, however, the AI may instead analyze raw data stored on the energy database 300 to arrive at its own energy transaction insights. For example, the AI 210 may utilize raw data as training data in a machine learning algorithm, such as a neural network. If actionable results are extracted from the analysis, the LBS 140 may optionally record these insights on the blockchain 3.

In various embodiments, the AI 210 may be programmed to minimize a cost basis for energy purchases, maximize a gain from sales, maximize a profit for the LBS 140, etc., but in other embodiments it may be configured to optimize for other objectives which may or may not be financial in nature. It should be understood that the two processes managed by the control unit, the power optimization events 201 and the energy transaction events 202, may be interdependent. For example, an increased frequency of energy transactions 202 may increase short-term profits for the LBS 140 but decrease the battery health and life cycle of the battery cells 141. In another scenario, such as where the LBS 140 is part of a UPS, the LBS 140 may be required to maintain full or near full charge for emergency applications. Accordingly, the AI 210 of the LBS 140 may be configured to balance a plurality of objectives, including but not limited to profit generation, battery longevity, energy security, and others, and may depend heavily on the applicational requirements of the LBS 140. No limitation is intended herein for the form, type, or number of goals programmed into the AI 210.

While the above-disclosed control unit 2, operating system 200, and blockchain 3 have been described with reference to an LBS 140, it should be understood that this is exemplary only and that the disclosed features may perform analogous functions with regard to other energy storage systems 14 and yet other components of the energy supply chain 1 as well. These components of the energy supply chain 1 may include, without limitation, energy storage systems 14 employing compressed air, mechanical flywheel, pumped-storage hydroelectric, electrochemical battery, thermal brick technology, etc.; generators 11 in the form of gas turbines, hydro turbines, wind turbines, solar photovoltaics, nuclear reactors, etc.; distributors 12 in a transmission network, distribution substation, electrical grid, etc.; and consumers 13 from commercial, industrial, residential, transportation sectors, etc.

In each of these embodiments, the component of the supply chain 1 may be managed by application-specific hardware, firmware, software systems, and/or operating systems. They may further comprise a plurality of application-specific metrics and states descriptive of that component’s operating status which necessarily depend upon the component’s function and hardware. Accordingly, the control unit 2 may employ a communication channel 24 to interface with the underlying OEM system 100. Moreover, the operating system 200 may be configured to operatively black-box the working details of each hardware device after integration. As previously discussed, the communication channel 24 may utilize a Modbus RTU protocol, Modbus TCP protocol, Modbus TCP/IP protocol, Alber™ BXE protocol, or similar standard transmission protocol to operatively connect to and communicate with the underlying hardware. Moreover, the control unit 2 may be configured with a Simple Network Management Protocol (SNMP) to identify and supply meaningful metrics from a MIB 110 associated with the OEM system 100. In this manner, the control unit 2 may interface with, query, and manipulate a variety of underlying component metrics and states regardless of the component type, hardware systems, software systems, or manufacturer. After accessing these metrics and functionality from the OEM system 100, the control unit 2 may further interpret and convert the data into a format congruent with the empirical energy database 300 stored on the blockchain 3. And once a connection is established between the control unit 2 and the hardware device, the networking unit 23 may operatively connect the control unit 2 to the blockchain 3 and facilitate data transfer therebetween.

In the manner discussed with regard to the exemplary LBS 140 energy storage system, the control unit 2 may run an operating system 200 that manages power optimization events 201 for the underlying component. To this end, the control unit 2 may connect to an empirical energy database 300 stored on the blockchain 3 that maintains a record of past optimization data 301. The data may be sourced from the same component, from an equivalent component (be it generator 11, distributor 12, consumer 13, or energy storage system 14), or from a disparate component of the energy supply chain 1 altogether. The power optimization data 301 from each component may be accessibly stored on the energy database 300 and made available to all parties. Likewise, as the present component accesses the blockchain 3, it may further contribute its own power optimization data 301 to the empirical energy database 300.

The control unit 2 may further employ an AI program 210 to manage its power optimization events 201. The AI 210 may analyze, among other things, a baseline ruleset 211 and the past power optimizations 301 recorded on the blockchain 3 in order to improve a performance of the present component in accordance with predetermined goals. In particular, the baseline ruleset 211 may be based on proprietary data and/or accepted industry practices specific to that component’s hardware systems. The purpose of the baseline ruleset 211 is to constrain the decision-making of the AI 210 within a safe solution space and to prevent dangerous experimentation during the power optimization event 201. At the same time, the AI 210 may analyze past power optimization data 301 stored on the blockchain 3. In some embodiments, the component may utilize insights stored on the blockchain 3, i.e. pre-analyzed data yielding actionable results, to inform its actions. In other embodiments, the AI 210 may instead analyze raw data to arrive at its own power optimization insights. For example, the AI 210 may utilize raw data recorded on the blockchain 3 as training data in a machine learning algorithm, such as a neural network. If actionable results are extracted from the analysis, the component may optionally record these insights on the energy database 300.

In the manner discussed with regard to the exemplary LBS 140 energy storage system, the operating system 200 of the control unit 2 may further manage energy transaction events 202 between the present component and one or more other components of the energy supply chain 1. For example, the control unit 2 may purchase a quantity of electricity from a generator 11, distributor 12, or energy storage system 14; the component may sell a quantity of electricity to the distributor 12, energy storage system 14, or consumer 13; or the component may maintain its current energy holdings. Each of these transactions may be securely arbitrated and immutably recorded on the blockchain 3 without the need for an intermediary or central authority. In an embodiment, each transaction may be between a unit of energy, e.g. a watt-hour, and a native digital asset of the blockchain 3.

Moreover, the control unit 2 may utilize past energy transaction data 302 stored on the blockchain 3 to guide its future trading decisions. The data may be contributed from the immediate component or any other component connected to the blockchain 3. The empirical energy database 300 may record the energy transaction data 302, which may describe the transaction type, quantity, price, date and time, etc., where no limitation is intended herein for the type or quantity of financial information being recorded. As the component accesses the energy database 300 for transaction data 302, it may further contribute data from its own energy transaction events 202.

In some embodiments, the control unit 2 may employ an AI program 210 to automatically manage its transactions 202. The AI 210 may consider, among other factors, the past transaction data 302 retrieved from the energy database 300 and one or more real-time market indicators 212 in order to improve the component’s transaction performance according to predetermined goals. In some embodiments, the component may utilize insights stored on the blockchain 3, i.e. pre-analyzed data yielding actionable results, to inform its actions. In other embodiments, the AI 210 may instead analyze raw data to arrive at its own transaction insights. For example, the AI 210 may utilize raw transaction data recorded on the energy database 300 as training data in a machine learning algorithm, such as a neural network. If actionable results are extracted from the analysis, the component may optionally record these insights on the blockchain 3.

In some embodiments, the AI 210 may be programmed to minimize a cost basis for energy purchases, maximize a gain from sales, maximize a profit for the component, etc., but in other embodiments it may be configured to optimize for objectives which may or may not be financial in nature. It should be understood that the two processes managed by the control unit 2, the power optimizations 201 and the energy transactions 202, may be interdependent. Accordingly, the AI 210 of the component may be configured to balance a plurality of obj ectives, including but not limited to profit generation, component longevity and reliability, energy security, and others, and may depend heavily on the applicational requirements of the underlying component. No limitation is intended herein for the form, type, or number of goals programmed into the AI 210.

Moreover, by connecting each component of the energy supply chain 1 through the blockchain 3, the energy supply chain 1 may be configured to prioritize global goals, as opposed to component-specific goals. For example, an individual wind turbine inverter focused on profit may be disincentivized from operating during periods of low demand due to low or even negative electricity prices. However, by enabling integration and communication between the wind turbine inverter and the energy supply chain 1, energy transaction events 202 may be configured that achieve mutually beneficial results for both the inverter and the transacting parties during these periods of low demand. Thus, in the above example, an energy supply chain 1 connected via the blockchain 3 may be used to incentivize a greater global renewable energy production. Through the blockchain 3, the energy supply chain 1 may be configured to optimize for a number of global objectives, including but not limited to increased renewable energy production, decreased transmission losses, improved supply chain liquidity, improved energy security, improved energy storage efficiency, carbon neutral objectives, and other predetermined goals.

In some embodiments, the control unit may further comprise a processing unit 22 with reconfigurable computing hardware, such as a field-programmable gate array (FPGA), to improve interoperability with the underlying OEM systems 100. The reconfigurable computing hardware may support regular updates to the control unit’s 2 software libraries without updates to the hardware systems or without reducing computing performance, allowing the control unit 2 to integrate and scale with potentially inflexible OEM systems 100. In another embodiment, the control unit’s 2 hardware systems may support polymorphic acceleration, such as those computing architectures applied to neural networks. The polymorphic accelerators may support additional control unit functionality, including without limitation blockchain node management, AI integration, redefinable communication interfaces, proprietary and standard communication protocols, and more.

Turning now to FIG. 6, a method of governing and recording energy management events within an energy supply chain 1 is disclosed. In block 601, a component of an energy supply chain 1 connects to a blockchain 3 recording a ledger of past energy management events, where the blockchain 3 may be stored on a network of interconnected nodes. In some embodiments, the component itself may act as a node in the network, and in other embodiments, the component may operatively connect to the blockchain 3 through a node independent of the component. And in other embodiments, for example where the component is managed by an OEM management system 100, data from the underlying control unit 2 may first be interpreted and converted into a format congruent with the blockchain 3 through a communication channel 24 prior to data transfer.

In block 602, a new block is created recording a new energy management event. The energy management event may be an energy transaction event 202 between the component of the energy supply chain 1 and a second component of the energy supply chain 1; or the energy management event may be a power optimization event 201. In block 603, the new block is validated through the network of interconnected nodes through a validation protocol in accordance with the state of the art. In various embodiments, the validation protocol may be a proof-of-stake protocol, a proof-of-work protocol, or a similar variant and, depending on the validation protocol, each node on the network may or may not be required to independently validate the new block prior to appendage to the blockchain 3. Thereafter, in block 604, the new block recording the energy management event is appended to the blockchain 3. Lastly, the component executes the new energy management event (605).

In some embodiments, the method may further comprise the component of the energy supply chain 1 utilizing data recorded on the blockchain 3 to guide its energy management events, which may be a power optimization 201 or an energy transaction 202. In particular, the component may analyze the metrics, past energy management events, results, and insights derived from the same or other components of the energy supply chain 1 pertaining to power optimization data 301 and/or energy transaction data 302.

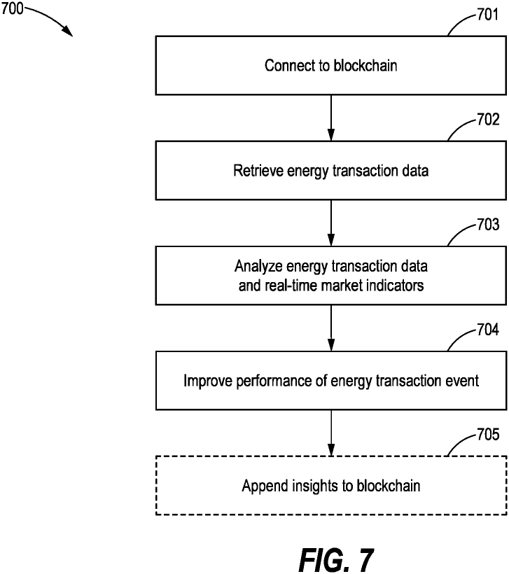

As seen in FIG. 7, wherein the energy management event is an energy transaction 202, the component may first connect to a blockchain 3 (block 701). In block 702, the component may retrieve from the blockchain 3 a plurality of past energy transaction data 302. Next, the component may analyze the plurality of past transactions and one or more real-time market indicators 212 to arrive at transaction insights; and/or the component may directly retrieve the insights prior stored on the blockchain (block 703). Then, in block 704, the component may use these insights to tune its behavior and improve a performance of its energy transactions 202 according to predetermined goals. In certain embodiments, the above analysis and retrieval may be executed in real-time in response to the real-time market indicators 212. And in other embodiments where the component has extracted actionable results from raw data, the component may further append the insights from its analysis to the blockchain 3 (block 705).

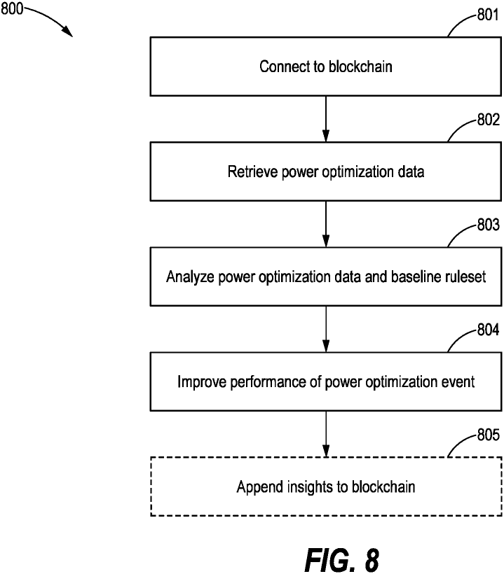

As seen in FIG. 8, wherein the energy management event is a power optimization 201, the component may first connect to a blockchain 3 (block 801). In block 802, the component may retrieve from the blockchain 3 a plurality of past power optimization data 301. Next, the component may analyze the plurality of past optimizations and a baseline ruleset 211 specific to the component to arrive at power optimization insights; and/or the component may directly retrieve the insights prior stored on the blockchain 3 (block 803). Then, in block 804, the component may use these insights to tune its behavior and improve a performance of its power optimizations 201 according to predetermined goals. In some embodiments where the component has extracted actionable results from raw data, the component may further append the insights from its analysis to the blockchain 3 (block 805).

By employing the hardware-agnostic control unit 2, operating system 200, blockchain 3, and empirical energy database 300 presently disclosed, an energy supply chain 1 may integrate its disparate components to mutually beneficial results, improving data security and accessibility, component interoperability and scalability, energy supply chain automation and decentralization, and yet other possible and envisioned benefits.

### INDUSTRIAL APPLICATION

The present disclosure may find industrial applicability in a number of individual components of an energy supply chain and may be particularly applicable to an energy supply chain as a whole. These components may include, without limitation, electric generators converting electricity from coal, natural gas, hydro, nuclear, wind, solar, and biofuel sources; transmission and distribution apparatus, including transmission lines, step up and step down transformers, and substations; consumers or end-users in residential, industrial, or commercial sectors; and energy storage systems employing pumped-storage hydroelectricity, lithium-ion batteries, flywheels, supercapacitors, or compressed air. Advantageously, the control unit and operating system may connect to and integrate with existing OEM management systems to provide hardware-agnostic energy management, while integration with the blockchain may enable secure data storage/retrieval and decentralized energy transactions.

While the disclosed methods may be employed with any number of components of an energy supply chain, it may find increased benefit with greater adoption or saturation within the supply chain. With each additional connected component, more raw data, analyses, measurable results, and actionable insights may be generated and distributed to each individual component. Consequently, the disclosed methods may reduce data silos, improve information parity, and improve an overall efficacy of an energy management system. Furthermore, increased collaboration between components of an energy supply chain may improve energy liquidity, increase energy efficiency, and enable more ambitious global goals, such as increasing renewable energy production or achieving carbon neutrality.

Indeed, the present disclosure may be particularly applicable towards energy supply chains and components thereof employing renewable energy technology. Compared to traditional energy sources, renewable generators tend to exhibit greater fluctuations in generation capacity as a function of time, season, climate, location, etc. The inherent variability in renewable power generation may further demand additional energy supply chain components, i.e. energy storage devices and transmission infrastructure, and the supply chain as a whole may experience greater transaction frequency and/or volume. Accordingly, renewable energy supply chains may particularly benefit from the energy management methods and implementations present disclosed.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

What is claimed is:

1. A computer-implemented method of governing and recording energy management events, comprising:
connecting to a blockchain recording a ledger of past energy management events;
creating a new block recording a new energy management event;
validating the new block through a network of interconnected nodes; appending the new block to the blockchain; and
executing the new energy management event.

2. A lithium-ion battery system (LBS) electrically connected to an energy supply chain, comprising:
at least one battery cell, each cell having one or more cell metrics;
at least one battery module electrically connecting the cells, each module having one or more module metrics; and
a control unit operatively connected to the cells and the modules, the control unit being configured to monitor and control the cell metrics, the module metrics, one or more system metrics, and one or more system states.

3. Lithium-ion battery system of claim 2 wherein the control unit further runs a computer-implemented method of governing and recording energy management events involving the LBS.

4. The computer-implemented method of claim 1 wherein the method further includes connecting to a blockchain recording a ledger of past energy management events; creating a new block recording a new energy management event; validating the new block through a network of interconnected nodes; appending the new block to the blockchain; and executing the new energy management event.

5. An energy supply chain, comprising:
a generator that generates electrical power from a non-electrical source;
a distributor that distributes electrical power between one or more components of the energy supply chain;
a consumer that consumers electrical power;
an energy storage system that converts and stores electrical energy to a non-electrical source; and
a plurality of control units each operatively connected to one of the generator, the distributor, the consumer, and the energy storage system.

6. The energy supply chain of claim 5, wherein each control unit further runs a computer-implemented method of governing and recording energy management events.
